(19) United States
(12) Patent Application Publication
(10) Pub. No.: US 2007/0171777 A1
(43) Pub. Date: Jul. 26, 2007

(54) Objective lens actuator and optical pickup device having the same

(75) Inventor: Kazuhiro Takahashi, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/657,578

(22) Filed: Jan. 25, 2007

(30) Foreign Application Priority Data
Jan. 25, 2006 (JP) 2006-015975

(51) Int. Cl. G11B 7/00

(52) U.S. Cl. 369/44.15

(57) ABSTRACT

An objective lens actuator is provided with an objective lens holder and an anti-collision member disposed at the upper portion of the objective lens holder for preventing a collision between the optical recording medium and the objective lens, and the anti-collision member includes a fixing portion for fixing to the objective lens holder, a gradient portion extending from the fixing portion in the same direction as a rotation direction of the optical recording medium in a slanting manner by a predetermined angle with respect to the optical recording medium, and a contact portion that extends from the gradient portion and has a surface substantially parallel with the recording surface of the optical recording medium, and when the anti-collision member contacts with the optical recording medium, it bends toward the objective lens holder.

This application is based on Japanese Patent Application No. 2006-015975 filed on Jan. 25, 2006, the contents of which are hereby incorporated by reference.

### BACKGROUND OF THE INVENTION

1. Field of the Invention

The present invention relates to an objective lens actuator that is mounted on an optical pickup device for projecting a light beam to an optical recording medium so that information can be recorded or reproduced on the optical recording medium. In particular, the present invention relates to a structure of an objective lens actuator that can prevent collision between an objective lens and the optical recording medium. Also, the present invention relates to an optical pickup device having such an objective lens actuator.

2. Description of Related Art

Optical recording media including a compact disc (hereinafter referred to as a CD) and a digital versatile disc (hereinafter referred to as a DVD) are widely available. Furthermore, in order to increase recording capacity of the optical recording medium, studies about high density recording on the optical recording medium have been proceeding these years. For example, high density optical recording media including an HD-DVD and a Blu-Ray Disc (hereinafter referred to as a BD) that are high quality DVDs are being available.

When such an optical recording medium is read or written, an optical pickup device is used for projecting a light beam to the optical recording medium so that information can be recorded or reproduced on the optical recording medium. When a high density optical recording medium such as a BD is used for recording or reproducing information with the optical pickup device, a wavelength of a light source of the optical pickup device is set to a shorter value (e.g., 405 nm for a BD). In addition, a numerical aperture (NA) of the objective lens is set to a larger value (e.g., NA=0.85 for a BD). Thus, it is necessary to decrease a diameter of a light beam spot formed on the optical recording medium by the light beam emitted from the light source. If the numerical aperture of the objective lens is increased, a distance between the tip of the objective lens and the optical recording medium when information is recorded or reproduced on the optical recording medium by using the optical pickup device (i.e., a working distance or a WD) becomes very small value.

In the optical pickup device, the objective lens is driven by the objective lens actuator so that a focal point of the light beam emitted from the light source can meet a recording surface of the optical recording medium continuously without affected by wobbling or the like of the optical recording medium. This control for maintaining a constant relationship between the objective lens and the optical recording medium may be referred to as a focus servo hereinafter.

However, as described above, recent optical pickup devices have a tendency to have a very small value of the WD. Therefore, if the focus servo becomes out of control due to a flaw on the optical recording medium or an external vibration for example, it may substantially increase the possibility of a collision between the objective lens and the optical recording medium. As a result of the collision between the objective lens and the optical recording medium, information recorded on the optical recording medium may become non-readable, or the optical pickup device may become non-usable because of damage to the objective lens. In order to avoid these malfunctions, various techniques are proposed conventionally.

For example, JP-A-2003-217163 describes a technique for preventing a direct contact between the objective lens and the optical recording medium by providing a buffer portion that protrudes from a flange of the objective lens. In addition, JP-A-5-109098 describes a technique for preventing a collision between the objective lens and the optical recording medium by disposing a lens anti-collision member made of an elastic adhesive protruding from an upper face of the objective lens holder that is provided to an objective lens driving device (objective lens actuator) for moving the objective lens.

In addition, JP-A-2002-373439 describes a technique for preventing a collision between the objective lens and the optical recording medium by disposing a floating slider between the optical recording medium and the objective lens holder. The floating slider is supported by an elastic member that is fixed to the basis and rises from the optical recording medium when the optical recording medium rotates. Moreover, JP-A-2003-157577 describes a technique for preventing a collision between the objective lens and the optical recording medium by using a repulsive force between two magnetic fields. One of the two magnetic fields is generated by a magnetic layer provided to the optical recording medium or by a magnetic material or a magnetic field generator that is disposed at the opposite side to the objective lens with respect to the optical recording medium. The other magnetic field is generated by a focusing actuator coil or by a magnetic material or a magnetic field generator that is disposed at an objective lens retaining portion.

However, the structure described in JP-A-2003-217163 or JP-A-5-109098 has a disadvantage that scars may be generated on a surface of the optical recording medium when the protruding buffer portion or the lens anti-collision member touches the optical recording medium, because of a touch impact or a frictional force with the rotating optical recording medium. Concerning this point, the structure described in JP-A-2002-373439 or JP-A-2003-157577 has less tendency to generate scars on the optical recording medium than the structure described in JP-A-2003-217163 or JP-A-5-109098, because the former structure has basically no possibility that the optical recording medium contacts the objective lens or the lens anti-collision member.

However, if a mechanical stopper is provided to the basis like the structure described in JP-A-2002-373439, a structure of a member for preventing the collision becomes larger than the structure described in JP-A-2003-217163 or JP-A-5-109098. As a result, it is difficult to adjust a position of the stopper when the optical pickup device is assembled. In addition, the floating slider supported by the elastic member is apt to swing and has little stability of its operation, so it has high probability of collision with the optical recording medium.

Furthermore, the structure described in JP-A-2003-157577 has a disadvantage that a structure of the optical recording medium becomes complicated or that a size of the device is increased because the magnetic material or the like is disposed at the opposite side to the objective lens with respect to the optical recording medium.

### SUMMARY OF THE INVENTION

In view of the above described problem, it is an object of the present invention to provide an objective lens actuator that has a function of preventing a collision between the objective lens and the optical recording medium and has a simple structure for preventing damage to the optical recording medium. Another object of the present invention is to provide an optical pickup device that can record and reproduce information with stability being equipped with an objective lens actuator that causes little damage to the objective lens and the optical recording medium.

To attain the above described object, the objective lens actuator according to one aspect of the present invention as a first structure includes: an objective lens; an objective lens holder having a hollow portion extending in an optical axis direction of the objective lens, the objective lens holder holding the objective lens on an optical recording medium side of the hollow portion; a magnetic circuit for driving the objective lens holder by a magnetic force; and an anti-collision member disposed on an objective lens supporting side of the objective lens holder so as to protrude from the objective lens holder, the anti-collision member preventing a collision between the objective lens and the optical recording medium, and the anti-collision member is provided with an optical recording medium damage prevention mechanism for preventing damage to the optical recording medium due to a contact between the anti-collision member and the optical recording medium.

As a second structure of the present invention, in the objective lens actuator having the structure described above, the optical recording medium damage prevention mechanism includes a mechanism for the anti-collision member to bend toward the objective lens holder when the anti-collision member contacts with the optical recording medium.

As a third structure of the present invention, in the objective lens actuator having the structure described above, the bending mechanism of the anti-collision member that bends toward the objective lens holder when the anti-collision member contacts with the optical recording medium is arranged in the direction of suppressing an increase of a contact pressure between the optical recording medium and the anti-collision member along with a rotation of the optical recording medium.

As a fourth structure of the present invention, in the objective lens actuator having the structure described above, the anti-collision member includes a fixing portion for fixing to the objective lens holder, a gradient portion extending from the fixing portion in the same direction as a rotation direction of the optical recording medium in a slanting manner by a predetermined angle with respect to the optical recording medium, and a contact portion that extends from the gradient portion and has a surface substantially parallel with the recording surface of the optical recording medium and may contact the optical recording medium.

As a fifth structure of the present invention, in the objective lens actuator having the structure described above, a roller is provided to a distal end portion of the anti-collision member, and the roller rotates together with a rotation of the optical recording medium when the anti-collision member contacts the optical recording medium.

As a sixth structure of the present invention, in the objective lens actuator having the structure described above, a distal end portion of the anti-collision member is shaped like a wing, and the distal end portion shaped like a wing receives a force toward the objective lens holder from air flow generated by a rotation of the optical recording medium.

As a seventh structure of the present invention, in the objective lens actuator having the structure described above, at least two of the anti-collision members are provided and disposed substantially symmetrically with respect to the objective lens.

As an eighth structure of the present invention, an optical pickup device is provided, which is equipped with the objective lens actuator having the structure described above.

To attain the above described object, the objective lens actuator according to another aspect of the present invention as a ninth structure includes an optical pickup device comprising a light source and an objective lens actuator including an objective lens for condensing a light beam emitted from the light source on a recording surface of an optical recording medium, an objective lens holder having a hollow portion extending in an optical axis direction of the objective lens, the objective lens holder holding the objective lens on an optical recording medium side of the hollow portion, a magnetic circuit for driving the objective lens holder by a magnetic force, and an anti-collision member disposed on an objective lens supporting side of the objective lens holder so as to protrude from the objective lens holder, the anti-collision member preventing a collision between the objective lens and the optical recording medium, and at least two of the anti-collision members are provided and disposed substantially symmetrically with respect to the objective lens, and each of the anti-collision members includes a fixing portion for fixing to the objective lens holder, a gradient portion extending from the fixing portion in the same direction as a rotation direction of the optical recording medium in a slanting manner by a predetermined angle with respect to the optical recording medium, and a contact portion that extends from the gradient portion and has a surface substantially parallel with the recording surface and may contact the optical recording medium, so that the anti-collision member can bend toward the objective lens holder when the anti-collision member contacts with the optical recording medium.

According to the first structure of the present invention, the anti-collision member has not only a function of preventing a collision between the objective lens and the optical recording medium but also a mechanism for preventing damage to the optical recording medium due to a contact between the anti-collision member and the optical recording medium. Therefore, not only damage to the objective lens but also damage to the optical recording medium can be prevented.

In addition, according to the second structure of the present invention, in the objective lens actuator having the first structure described above, an impact when the anti-collision member contacts the objective lens holder is softened and also a contact pressure between the anti-collision member and the optical recording medium can be reduced because the anti-collision member bends toward the objective lens holder when the anti-collision member contacts the optical recording medium. Therefore, even if a contact between them occurs, damage to the optical recording medium is hardly generated.

In addition, according to the third structure of the present invention, in the objective lens actuator having the second structure described above, an excessive load is hardly applied to the optical recording medium so that damage to the optical recording medium can be prevented easily even if the anti-collision member contacts the optical recording medium and if the optical recording medium continues to rotate.

In addition, according to the fourth structure of the present invention, in the objective lens actuator having the third structure described above, a simple structure of the anti-collision member for preventing damage to the optical recording medium can be realized.

In addition, according to the fifth structure of the present invention, in the objective lens actuator having the first structure described above, a frictional force between the anti-collision member and the optical recording medium can be reduced when the anti-collision member contacts the optical recording medium because the roller provided to the anti-collision member rotates together with the rotation of the optical recording medium. Therefore, damage to the optical recording medium is hardly generated even if a contact between them occurs.

In addition, according to the sixth structure of the present invention, in the objective lens actuator having the first structure described above, the anti-collision member having the distal end portion shaped like a wing receives a force toward the objective lens holder when the optical recording medium rotates. Therefore, a contact between the anti-collision member and the optical recording medium can be avoided. Even if they contact each other, an impact due to the contact can be softened. Therefore, there is little possibility of damage to the optical recording medium.

In addition, according to the seventh structure of the present invention, in the objective lens actuator having one of the first to the sixth structures described above, a possibility of damage to the optical recording medium can further be reduced because of the arrangement in which the anti-collision member can exert its effect easily.

In addition, according to the eighth structure of the present invention, in the optical pickup device equipped with the objective lens actuator having one of the first to the seventh structures described above, information can be recorded and reproduced with stability because damages to the objective lens and to the optical recording medium are hardly generated.

According to the ninth structure of the present invention, the anti-collision member is configured not only to prevent a collision between the objective lens and the optical recording medium but also to bend when the anti-collision member contacts the optical recording medium. Therefore, an impact due to the contact between the anti-collision member and the optical recording medium is softened, and a contact pressure between the anti-collision member and the optical recording medium can be reduced. Furthermore, since the bending portion is arranged in the direction of suppressing an increase of the contact pressure between the optical recording medium and the anti-collision member along with a rotation of the optical recording medium, an excessive load is hardly applied to the optical recording medium. Therefore, possibility of both the damages to the objective lens and the optical recording medium of the optical pickup device can be reduced, so that an optical pickup device that can record and reproduce information with stability can be provided.

### BRIEF DESCRIPTION OF THE DRAWINGS

FIG. 1 is a schematic diagram to show a structure of an optical system of an optical pickup device according to embodiments of the present invention.

FIG. 2 is a schematic top view to show a structure of an objective lens actuator according to a first embodiment of the present invention.

FIG. 3 is a schematic side view to show a structure of the objective lens actuator according to the first embodiment.

FIG. 4 is a cross sectional view when cut along the line A-A in FIG. 3.

FIG. 5 is an enlarged schematic cross sectional view of an anti-collision member and its periphery in the objective lens actuator according to the first embodiment.

FIG. 6 is a schematic cross sectional view to show a variation of the objective lens actuator according to the present invention.

FIG. 7 is an enlarged schematic cross sectional view of an anti-collision member and its periphery in an objective lens actuator according to a second embodiment of the present invention.

FIG. 8 is an enlarged schematic cross sectional view of an anti-collision member and its periphery in an objective lens actuator according to a third embodiment of the present invention.

### DESCRIPTION OF THE PREFERRED EMBODIMENTS

Now, embodiments of the present invention will be described with reference to the attached drawings. The embodiments described below are merely examples, and the present invention is not limited to the embodiments.

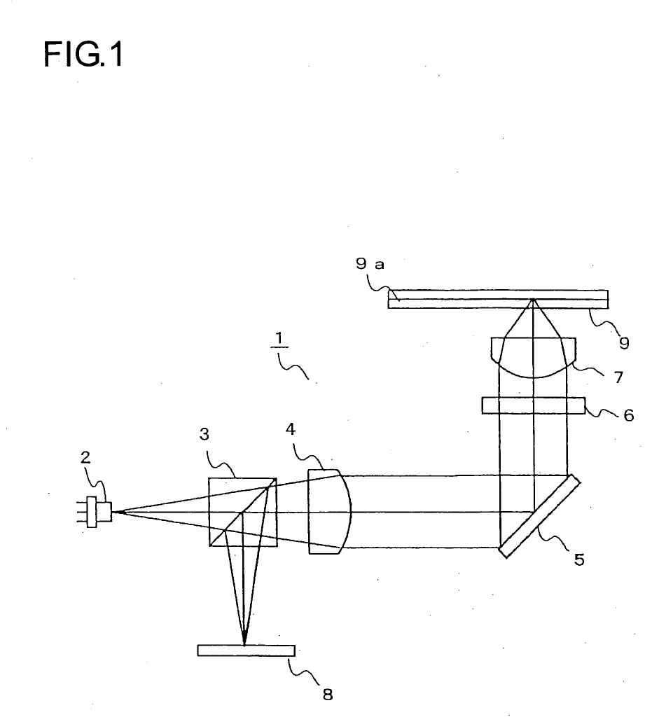

FIG. 1 is a schematic diagram to show a structure of an optical system of an optical pickup device that is equipped with an objective lens actuator according to the present invention. In FIG. 1, numeral 1 denotes the optical pickup device, which projects a light beam to an optical recording medium 9 such as a CD, a DVD, a BD or the like and receives a reflection light from the optical recording medium 9, so that information recorded on a recording surface 9a of the optical recording medium 9 is reproduced or information is recorded on the recording surface 9a of the optical recording medium 9. The optical system of this optical pickup device 1 is equipped with a light source 2, a beam splitter 3, a collimator lens 4, an upstand mirror 5, a quarter wavelength plate 6, an objective lens 7, and a photodetectors 8, for example. Hereinafter, details of the optical elements will be described.

The light source 2 is made up of a semiconductor laser. If the optical pickup device 1 is a one for a BD, the light source 2 emits a light beam of a 405 nm band, for example. Otherwise, if the optical pickup device 1 is a one for a CD or a DVD, the light source 2 emits a light beam of a 780 nm band or a 650 nm band, respectively, for example.

Although only one light source having a single wavelength is disposed in the present embodiment, other structures are possible. For example, it is possible to arrange a plurality of light sources each having a single wavelength. Alternatively, a two-wavelength combination light source housed in a single package may be used for the light source, for example.

The beam splitter 3 works as a separation element for separating a light beam. It permits the light beam emitted from the light source 2 to pass through and leads the light beam to the optical recording medium 9, while it reflects the reflection light reflected by the optical recording medium 9 and leads the light beam to the photo detector 8. The light beam that passed through the beam splitter 3 is sent to the collimator lens 4.

The collimator lens 4 is a lens that converts the light beam that passed through the beam splitter 3 into parallel rays. At this point, the term “parallel rays” means light including light rays emitted from the light source 2 all of which have optical paths that are substantially parallel with the optical axis. The parallel rays that passed through the collimator lens 4 are sent to the upstand mirror 5.

The upstand mirror 5 reflects the light beam that passed through the collimator lens 4 and leads the light beam to the optical recording medium 9. The upstand mirror 5 is tilted from the optical axis of the light beam from the collimator lens 4 by 45 degrees. The optical axis of the light beam reflected by the upstand mirror 5 is substantially perpendicular to the recording surface 9a of the optical recording medium 9. The light beam reflected by the upstand mirror 5 is sent to the quarter wavelength plate 6.

The quarter wavelength plate 6 converts the light beam of linear polarization emitted from the light source 2 and reflected by the upstand mirror 5 into a light beam of circular polarization. The light beam that passed through the quarter wavelength plate 6 is sent to the objective lens 7.

The objective lens 7 condenses the light beam that passed through the quarter wavelength plate 6 on the recording surface 9a of the optical recording medium 9. The numerical aperture (NA) of the objective lens 7 is set as NA=0.85 if the optical pickup device 1 is for a BD. Furthermore, if the optical pickup device 1 is for a CD or a DVD for example, it is set as NA=0.5 or NA=0.65. This objective lens 7 is mounted on the objective lens actuator that will be described later and is structured to be capable of moving in a predetermined direction.

The reflection light reflected by the optical recording medium 9 passes through the objective lens 7 and the quarter wavelength plate 6. The reflection light that passed through the quarter wavelength plate 6 is converted into light of linear polarization. In this case, the polarization angle of the linear polarization is shifted from the polarization angle of the light beam emitted from the light source 2 by 90 degrees. The reflection light that passed through the quarter wavelength plate 6 is reflected by the upstand mirror 5 and is reflected by the beam splitter 3 after passing through the collimator lens 4. Then, the reflection light reaches a light receiving portion (not shown) of the photo detector 8.

The photo detector 8 converts the received light information into an electric signal, which is outputted to an RF amplifier (not shown) or the like, for example. Then, this electric signal is used as a reproduction signal of data recorded on the recording surface 9a and further as a servo control signal for performing a focus control or a tracking control.

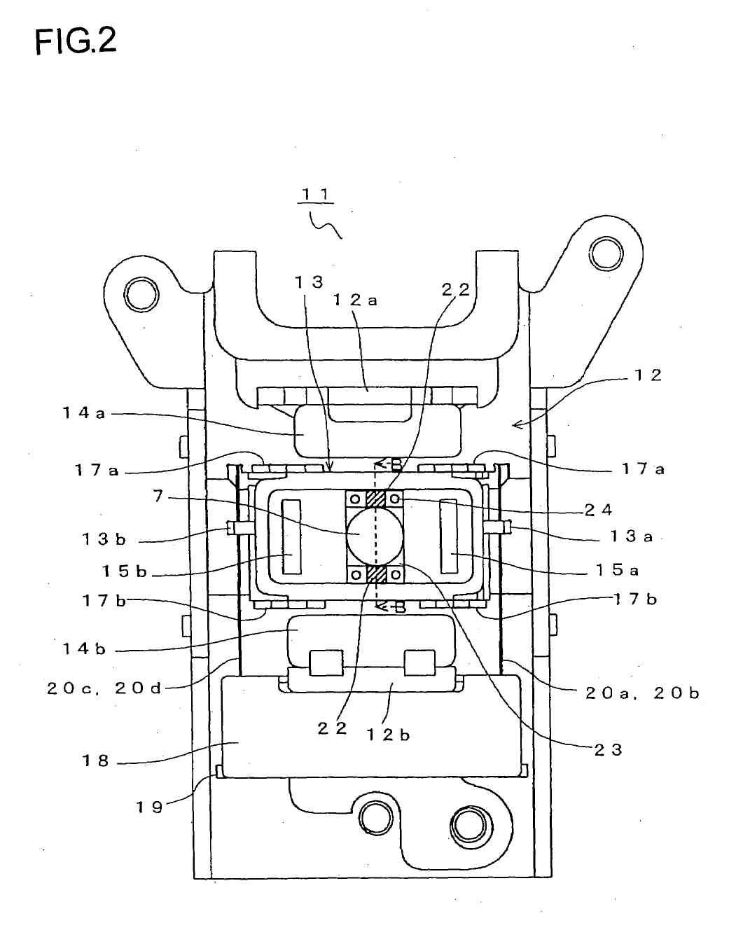

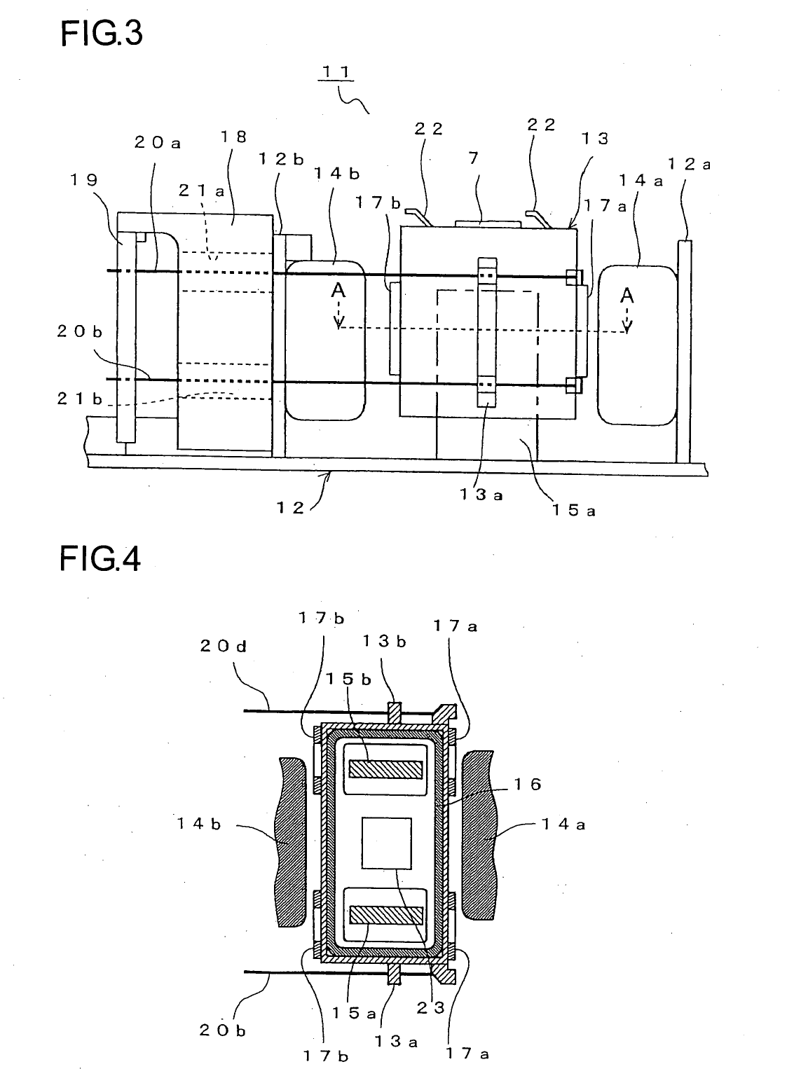

Next, details of an objective lens actuator 11 of a first embodiment that is provided to the optical pickup device 1 will be described with reference to FIGS. 2-4. FIG. 2 is a schematic top view to show a structure of the objective lens actuator 11 according to the first embodiment, FIG. 3 is a schematic side view to show a structure of the objective lens actuator 11 according to the first embodiment, and FIG. 4 is a cross sectional view when cut along the line A-A in FIG. 3.

The objective lens actuator 11 is basically made up of a metallic base member 12 having ferromagnetism and an objective lens holder 13 that is a resin molding component. A through hole (not shown) is formed substantially at the center of the base member 12 so as to permit the light beam from the light source 2 (see FIG. 1) to pass through, and the objective lens holder 13 is arranged there, which will be described later in detail. In addition, a pair of permanent magnets 14a and 14b are arranged to stand on the base member 12, and they face each other so as to sandwich the objective lens holder 13 with a predetermined gaps. The outer faces of these permanent magnets 14a and 14b are respectively attracted magnetically and fixed to the protrusions 12a and 12b that are shaped to bend from the base member 12. Thus, the permanent magnets 14a and 14b are fixed to the base member 12 in a magnetically integrated manner.

In addition, a pair of yokes 15a and 15b are arranged to stand on the base member 12 between the permanent magnets 14a and 14b so that they face each other in the direction perpendicular to the facing direction of the permanent magnets 14a and 14b. These yokes 15a and 15b are shaped to bend from the base member 12. At this point, the yokes 15a and 15b have a role of drawing magnetic fluxes from the permanent magnets 14a and 14b so that high density magnetic fluxes are given mainly to a focus coil 16 and tracking coils 17a and 17b disposed between them, which will be described later. Thus, drive efficiency of the objective lens holder 13 can be enhanced.

The objective lens holder 13 has a hollow portion 23 extending vertically (in the direction perpendicular to the paper in FIG. 2) at the middle portion, and the objective lens 7 is mounted on an objective lens retaining portion (not shown) that is disposed above the hollow portion. At this point, the objective lens 7 is mounted so that its optical axis becomes parallel with the vertical direction. The yokes 15a and 15b penetrate the space so as to sandwich the objective lens 7.

Inside the side wall of this objective lens holder 13, the focus coil 16 is placed so as to surround the optical axis of the objective lens 7. The focus coil 16 is fixed to the objective lens holder 13 by adhesive agent or the like. In addition, the tracking coils 17a and 17b are fixed by adhesive agents or the like to the outer face of the side wall of the objective lens holder 13 at the opposed sides facing the permanent magnets 14a and 14b, respectively. Two pairs of the tracking coils 17a and 17b are formed so that each pair faces the yokes 15a or 15b (see FIG. 2), and they are connected in series as a whole.

In addition, a gel holder 18 that is a resin molding component made of polycarbonate or the like is fixed to the outer face side of the protrusion 12b to which one of the permanent magnet 14b is fixed magnetically on the base member 12. Further, a circuit board 19 is placed to stand neighboring to the outside of the gel holder 18. One of ends of each conductive wire 20a, 20b, 20c, and 20d are soldered to the circuit board 19 at the right and left sides of the circuit board 19 (see FIG. 2) at two positions in the vertical direction (see FIG. 3). Each of these four wires 20a-20d passes through each of through holes 21a, 21b, 21c, and 21d formed in the gel holder 18 at positions corresponding to the connection to circuit board 19, i.e., at the right and left sides at two positions in the vertical direction.

In addition, the wires 20a-20d are bonded by adhesive agent or the like to spines 13a and 13b protruding from the right and left sides of the objective lens holder 13. Thus, the objective lens holder 13 is supported by the wires 20a-20d in a shakable manner with respect to the base member 12. Then, the other ends of the wires 20a and 20c are soldered to the focus coil 16, while the other ends of the wires 20b and 20d located at the lower position are soldered to the tracking coils 17a and 17b.

Each of the through holes 21a-21d of the gel holder 18, which the wires 20a-20d pass through, is filled with a gel material whose main ingredient is silicone. The gel material is formed by irradiating ultraviolet rays a predetermined period of time to low-viscosity gel material (sol) that is injected into the through holes 21a-21d of the gel holder 18 so that the material is cured into a gel state. This gel holder 18 plays a role of absorbing and reducing vibration generated in the wires 20a-20d due to drive of the objective lens holder 13 by the gel material.

When current is supplied to the focus coil 16 from the circuit board 19 via the wires 20a and 20c in the objective lens actuator 11 having the structure described above, base member 12, an electromagnetic force is generated between the focus coil 16 and a magnetic circuit formed by the permanent magnets 14a and 14b and the yokes 15a and 15b. As a result, the objective lens holder 13 can be driven to move in the direction perpendicular to the paper in FIG. 2 (i.e., in the vertical direction in FIG. 3). Thus, the position of the objective lens 7 in the focus direction can be adjusted by adjusting the value and the direction of the current to be supplied to the focus coil 16.

In addition, when current is supplied to the tracking coils 17a and 17b from the circuit board 19 via the wires 20b and 20d, an electromagnetic force is generated between each of the tracking coils 17a and 17b and a magnetic circuit formed by the base member 12, the permanent magnets 14a and 14b and the yokes 15a and 15b. As a result, the objective lens holder 13 can be driven to move in the horizontal direction in FIG. 2 (in the direction perpendicular to the paper in FIG. 3). Thus, the position of the objective lens 7 in the tracking direction (i.e., in the radial direction of the optical recording medium 9) can be adjusted by adjusting the value and the direction of the current to be supplied to the tracking coils 17a and 17b.

At this point, the objective lens actuator 11 in the present embodiment can move the objective lens 7 only in two directions, i.e., in the focus direction and in the tracking direction. However, in addition to the two directions, it is possible to add a coil for a tilt control so that the objective lens 7 can be tilted with respect to the optical axis of the light beam reflected by the upstand mirror 5 (see FIG. 1) for a purpose of compensation of coma aberration, for example.

In the objective lens actuator 11 of the first embodiment, the objective lens holder 13 is provided with an anti-collision member 22 as shown in FIGS. 2 and 3 for preventing a collision between the objective lens 7 and the optical recording medium 9 when the position of the objective lens 7 is adjusted in the focus direction. Although two anti-collision members 22 are disposed substantially symmetrically with respect to the objective lens 7 in the present embodiment, this structure should not be interpreted in a limited manner. For example, within the scope of the present invention, it is possible to arrange four or more even number of anti-collision members 22 substantially symmetrically with respect to the objective lens 7. In addition, it is not always necessary to arrange the anti-collision members 22 precisely in the symmetric positions with respect to the objective lens 7.

FIG. 5 is a diagram for explaining the structure of the anti-collision member 22 provided to the objective lens holder 13 of the first embodiment more in detail and shows a part of a cross sectional view when cut along the line B-B in FIG. 2. At this point, the optical recording medium 9 is also shown in FIG. 5 for convenience of description. The anti-collision member 22 is made up of a fixing portion 22a for fixing to the objective lens holder 13, a gradient portion 22b extending from the fixing portion 22a upward in a slanting direction, and a contact portion 22c that extends from the gradient portion 22b substantially in the horizontal direction (in the direction substantially parallel with the recording surface 9a of the optical recording medium 9) and may touch the optical recording medium 9.

The fixing portion 22a is provided with a rib hole (not shown) through which a rib 24 (see FIG. 2) that is provided to the objective lens holder 13 penetrates, so that the anti-collision member 22 is fixed to the objective lens holder 13. The gradient portion 22b is formed to have a predetermined gradient so as to be close to the recording surface 9a as going to the downstream side in the rotation direction of the optical recording medium 9 (the direction of the long arrow in FIG. 5). Further, the height of the gradient portion 22b is adjusted so that the position of the contact portion 22c of the anti-collision member 22 is higher than the objective lens 7. The anti-collision member 22 consisting of the fixing portion 22a, the gradient portion 22b and the contact portion 22c is molded integrally as a member made of a resin such as polyacetal.

The anti-collision member 22 is provided for preventing a collision between the objective lens 7 and the optical recording medium 9 as described above. This anti-collision member 22 further includes an optical recording medium damage prevention mechanism for preventing damage to the optical recording medium 9 due to a contact between the optical recording medium 9 and the anti-collision member 22. More specifically, when the anti-collision member 22 contacts the optical recording medium 9, the anti-collision member 22 bends downward (toward the objective lens holder 13) because of the presence of the gradient portion 22b. As a result, the contact pressure is reduced when the anti-collision member 22 contacts the optical recording medium 9, so that damage to the optical recording medium 9 can be prevented.

In addition to the structure of anti-collision member 22 that can bend downward, the gradient portion 22c is slanted in the same direction as the rotation direction of the optical recording medium 9. Therefore, if the anti-collision member 22 contacts the optical recording medium 9 and if the optical recording medium 9 continues to rotate in the sate, an increase of the contact pressure between the optical recording medium 9 and the anti-collision member 22 can be suppressed, so that an excessive load is hardly applied to the optical recording medium 9. Therefore, a probability of damage to the optical recording medium 9 can be reduced further.

At this point, the height of the anti-collision member 22 is adjusted and the material thereof is selected appropriately so that the optical recording medium 9 and the objective lens 7 never collides even if the anti-collision member 22 touches the optical recording medium 9 and bends.

Although the anti-collision member 22 is made as a resin molding component in the first embodiment, this structure should not be interpreted as a limitation. For example, it is possible to form the anti-collision member 22 as a metal component made of a copper or the like.

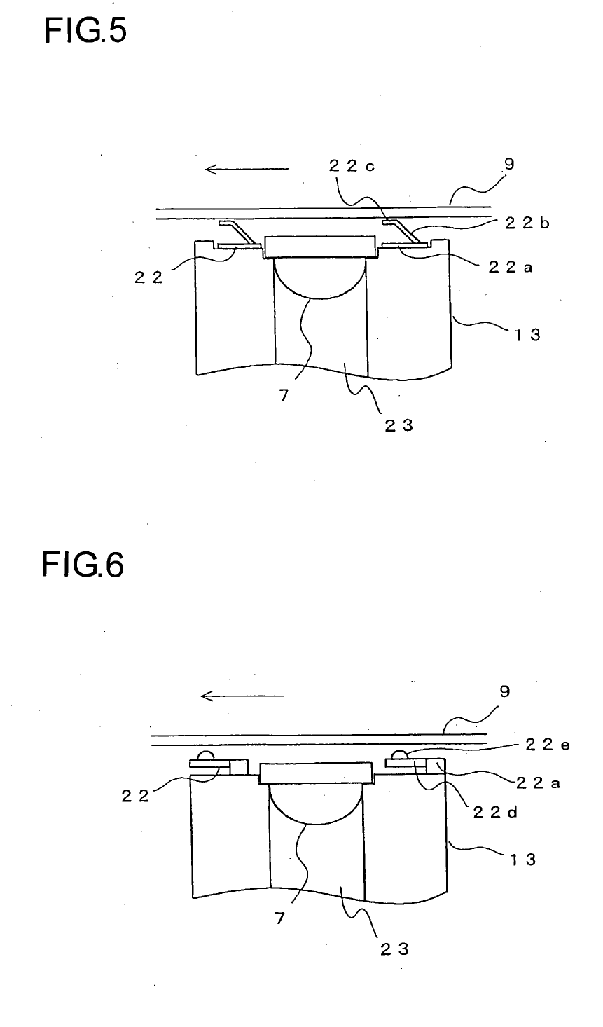

In addition, the structure of the anti-collision member 22 for bending toward the objective lens holder is not limited to the structure of the first embodiment. The structure can be modified variously within the scope of the present invention. For example, it is possible that the anti-collision member 22 has a structure as shown in FIG. 6. The anti-collision member 22 shown in FIG. 6 includes a fixing portion 22a for fixing to the objective lens holder 13, a plate portion 22d extending from the fixing portion 22a in the same direction as the rotation direction of the optical recording medium 9 in the floating state, and a protruding portion 22e having a spherical shape formed on the plate portion 22d. The long arrow in FIG. 6 indicates the rotation direction of the optical recording medium.

In this structure, when the optical recording medium 9 becomes close to the objective lens 7, the protruding portion 22e contacts the optical recording medium 9, and the plate portion 22d bends downward so that the impact due to the contact of the optical recording medium 9 with the anti-collision member 22 is softened. Furthermore, since the plate portion 22d extends in the same direction as the rotation direction of the optical recording medium 9 in the floating state, an increase of the contact pressure between the optical recording medium 9 and the anti-collision member 22 can be suppressed if the anti-collision member 22 contacts the optical recording medium 9 and if the optical recording medium 9 continues to rotate in the state. As a result, an excessive load is hardly applied to the optical recording medium 9. Therefore, a probability of damage to the optical recording medium 9 can be reduced further.

As another structure of the first embodiment, it is possible to tilt the gradient portion 22b of the anti-collision member 22 shown in FIG. 5 in the direction opposite to the rotation direction of the optical recording medium 9. In this case too, it is possible that the anti-collision member 22 softens the impact due to the contact with the optical recording medium 9. However, there is a possibility in this case that the contact pressure between the optical recording medium 9 and the anti-collision member 22 increases when the optical recording medium 9 continues to rotate in the contact state with the anti-collision member 22 and that an excessive load is applied to the optical recording medium 9. Concerning this point, it is possible to take the following countermeasure against it. For example, it is possible to adopt the structure in which when the optical recording medium 9 contacts with the anti-collision member 22, the objective lens actuator 11 drives the objective lens 7 to move in the separating direction from the optical recording medium 9 promptly.

Next, a second embodiment of the objective lens actuator 11 provided to the optical pickup device 1 will be described. The objective lens actuator 11 of the second embodiment is similar to the objective lens actuator 11 of the first embodiment except for the structure of the anti-collision member 22. Therefore, only the structure of the anti-collision member 22 that is different will be described. At this point, the same members as the first embodiment are denoted by the same reference numerals.

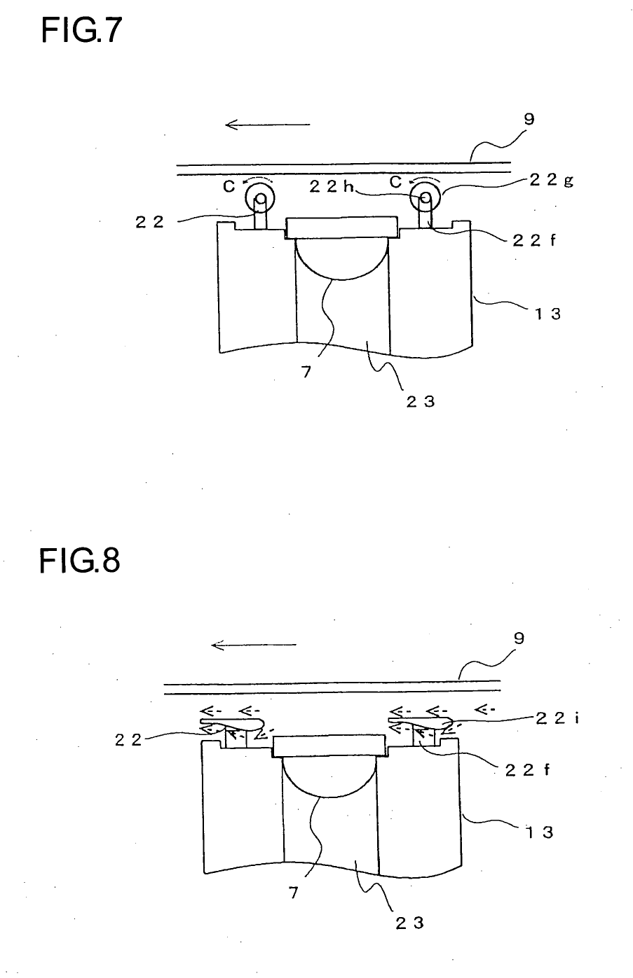

FIG. 7 is an enlarged schematic cross sectional view to show the anti-collision member 22 and its periphery in the objective lens actuator 11 of the second embodiment. For convenience sake in description, the optical recording medium 9 is also shown in FIG. 7. As shown in FIG. 7, the anti-collision member 22 includes supporter portions 22f, a spindle 22h and a roller 22g. The supporter portions 22f are arranged so as to face each other and to sandwich the roller 22g (only the front supporter portion 22f is shown, and the rear supporter portion 22f is hidden in the direction perpendicular to the paper in FIG. 7), and they are fixed to the objective lens holder 13. Each of the supporter portions 22f is provided with a bearing (not shown) for retaining the spindle 22h. The long arrow in FIG. 7 also indicates the rotation direction of the optical recording medium.

The spindle 22h pass through the center of the roller 22g and is supported by the supporter portions 22f in a rotatable manner. The roller 22g is positioned in a rotatable manner in the direction of the arrow with a broken line in FIG. 7 in consideration of the rotation direction of the optical recording medium 9. The anti-collision member 22 having this structure can prevent a collision between the objective lens 7 and the optical recording medium 9 because the anti-collision member 22 is formed to be higher than the tip portion of the objective lens 7. Then, similarly to the case of the first embodiment, the anti-collision member 22 of the second embodiment also has the optical recording medium damage prevention mechanism for preventing damage to the optical recording medium 9 due to a contact between the optical recording medium 9 and the anti-collision member 22.

More specifically, when the anti-collision member 22 contacts with the optical recording medium 9, the roller 22g provided to the distal end of the anti-collision member 22 rotates in the direction of the arrow C together with the rotation of the optical recording medium 9. As a result, friction between the anti-collision member 22 and the optical recording medium 9 is reduced, and damage of the optical recording medium 9 due to the friction between the optical recording medium 9 and the anti-collision member 22 can be prevented.

The structure of preventing damage to the optical recording medium 9 by the roller 22g provided to the anti-collision member 22 should not be limited to the structure of the second embodiment, but it can be modified variously within the scope of the present invention. For example, it is possible to provide an elastic member to the bearing of the supporter portion 22f of the anti-collision member 22, so that the spindle 22h penetrating the roller 22g sinks toward the objective lens holder 13 when the optical recording medium 9 contacts with the anti-collision member 22. Thus, it is possible to soften the impact due to the contact between the optical recording medium 9 and the anti-collision member 22.

Next, a third embodiment of the objective lens actuator 11 provided to the optical pickup device 1 will be described. The objective lens actuator 11 of the third embodiment is similar to the objective lens actuator 11 of the first embodiment except for the structure of the anti-collision member 22. Therefore, only the structure of the anti-collision member 22 that is different will be described. At this point, the same members as the first embodiment will be denoted by the same reference numerals.

FIG. 8 is an enlarged schematic cross sectional view to show the anti-collision member 22 and its periphery in the objective lens actuator 11 according to third embodiment. At this point, the optical recording medium 9 is also shown in FIG. 8 for the sake of convenience of description. As shown in FIG. 8, the anti-collision member 22 includes a supporter portion 22f and a distal end portion 22i that is formed like a wing. The supporter portion 22f is fixed to the objective lens holder 13, and a wing-like member (the distal end portion 22i shaped like a wing) is disposed to the distal end of the supporter portion 22f. In this case, the distal end portion 22i formed like a wing is arranged so that air flow generated by the rotation of the optical recording medium has higher speed in the side of the objective lens holder 13 than in the side of the optical recording medium 9. The long arrow in FIG. 8 also indicates the rotation direction of the optical recording medium.

The anti-collision member 22 having this structure can prevent a collision between the objective lens 7 and the optical recording medium 9 because the anti-collision member 22 is formed to be higher than the distal end portion of the objective lens 7. Then, similarly to the case of the first embodiment, the anti-collision member 22 of the third embodiment also has the optical recording medium damage prevention mechanism for preventing damage to the optical recording medium 9 due to a contact between the optical recording medium 9 and the anti-collision member 22.

More specifically, since the air flow is generated by the rotation of the optical recording medium 9 (as shown in FIG. 8 by the arrows with broken lines), the distal end portion 22i like a wing of the anti-collision member 22 receives a force toward the objective lens holder 13d in which air density is smaller when the objective lens holder 13 becomes close to the optical recording medium 9. As a result, it is possible to avoid a contact between the optical recording medium 9 and the anti-collision member 22. In addition, even if the optical recording medium 9 contacts with the anti-collision member 22, the impact due to the contact between the optical recording medium 9 and the anti-collision member 22 can be softened because the anti-collision member 22 receives a force toward the objective lens holder 13. As a result, damage to the optical recording medium 9 can be prevented by presence of the anti-collision member 22 of the third embodiment.

Although the objective lens actuator 11 in the embodiments described above is a so-called wire supporting actuator in which the objective lens holder 13 that holds the objective lens 7 is supported by a plurality of wires (metal wires) in a shakable manner with respect to the base member 12. However, the present invention is not limited to this structure but can be applied to other structures such as a two-shaft actuator of a shaft sliding type.

The present invention is applied to an objective lens actuator including an objective lens, an objective lens holder having a hollow portion extending in an optical axis direction of the objective lens, the objective lens holder holding the objective lens on an optical recording medium side of the hollow portion, a magnetic circuit for driving the objective lens holder by a magnetic force, and an anti-collision member disposed on an objective lens supporting side of the objective lens holder so as to protrude from the objective lens holder, the anti-collision member preventing a collision between the objective lens and the optical recording medium. In this structure, the anti-collision member is provided with an optical recording medium damage prevention mechanism for preventing damage to the optical recording medium due to a contact between the anti-collision member and the optical recording medium.

Thus, the anti-collision member has not only a function of preventing a collision between the objective lens and the optical recording medium but also a mechanism for preventing damage to the optical recording medium due to a contact between the anti-collision member and the optical recording medium. Therefore, not only damage to the objective lens but also damage to the optical recording medium can be prevented.

In addition, since the anti-collision member is configured to bend toward the objective lens holder when the anti-collision member contacts the optical recording medium, a contact pressure due to the contact between the optical recording medium and the anti-collision member can be reduced. Thus, damage to the optical recording medium can be prevented.

In addition, since the distal end portion of the anti-collision member is provided with a roller so that the roller rotates together with the rotation of the optical recording medium when the anti-collision member contacts the optical recording medium, a frictional force due to the contact between the optical recording medium and the anti-collision member can be softened.

In addition, since the distal end portion of the anti-collision member is shaped like a wing so that the distal end portion shaped like a wing receives a force toward the objective lens holder from air flow generated by the rotation of the optical recording medium, a contact between the optical recording medium and the anti-collision member can be avoided. Otherwise, an impact due to a contact between them can be softened.

In addition, the optical pickup device equipped with the objective lens actuator described above hardly generates damage to the objective lens and damage to the optical recording medium, so it can record and reproduce information with stability.

What is claimed is:

1. An objective lens actuator comprising:
an objective lens;
an objective lens holder having a hollow portion extending in an optical axis direction of the objective lens, the objective lens holder holding the objective lens on an optical recording medium side of the hollow portion;
a magnetic circuit for driving the objective lens holder by a magnetic force; and
an anti-collision member disposed on an objective lens supporting side of the objective lens holder so as to protrude from the objective lens holder, the anti-collision member preventing a collision between the objective lens and the optical recording medium, wherein
the anti-collision member is provided with an optical recording medium damage prevention mechanism for preventing damage to the optical recording medium due to a contact between the anti-collision member and the optical recording medium.

2. The objective lens actuator according to claim 1, wherein the optical recording medium damage prevention mechanism includes a mechanism for the anti-collision member to bend toward the objective lens holder when the anti-collision member contacts with the optical recording medium.

3. The objective lens actuator according to claim 2, wherein a bending portion of the anti-collision member that bends toward the objective lens holder when the anti-collision member contacts with the optical recording medium is arranged in the direction of suppressing an increase of a contact pressure between the optical recording medium and the anti-collision member along with a rotation of the optical recording medium.

4. The objective lens actuator according to claim 3, wherein the anti-collision member includes a fixing portion for fixing to the objective lens holder, a gradient portion extending from the fixing portion in the same direction as a rotation direction of the optical recording medium in a slanting manner by a predetermined angle with respect to the optical recording medium, and a contact portion that extends from the gradient portion and has a surface substantially parallel with the recording surface of the optical recording medium and may contact the optical recording medium.

5. The objective lens actuator according to claim 1, wherein a roller is provided to a distal end portion of the anti-collision member, and the roller rotates together with a rotation of the optical recording medium when the anti-collision member contacts the optical recording medium.

6. The objective lens actuator according to claim 1, wherein a distal end portion of the anti-collision member is shaped like a wing, and the distal end portion shaped like a wing receives a force toward the objective lens holder from air flow generated by a rotation of the optical recording medium.

7. The objective lens actuator according to claim 1, wherein at least two of the anti-collision members are provided and disposed substantially symmetrically with respect to the objective lens.

8. The objective lens actuator according to claim 2, wherein at least two of the anti-collision members are provided and disposed substantially symmetrically with respect to the objective lens.

9. The objective lens actuator according to claim 3, wherein at least two of the anti-collision members are provided and disposed substantially symmetrically with respect to the objective lens.

10. The objective lens actuator according to claim 4, wherein at least two of the anti-collision members are provided and disposed substantially symmetrically with respect to the objective lens.

11. The objective lens actuator according to claim 5, wherein at least two of the anti-collision members are provided and disposed substantially symmetrically with respect to the objective lens.

12. The objective lens actuator according to claim 6, wherein at least two of the anti-collision members are provided and disposed substantially symmetrically with respect to the objective lens.

13. An optical pickup device equipped with the objective lens actuator according to claim 1.

14. An optical pickup device comprising a light source and an objective lens actuator including an objective lens for condensing a light beam emitted from the light source on a recording surface of an optical recording medium, an objective lens holder having a hollow portion extending in an optical axis direction of the objective lens, the objective lens holder holding the objective lens on an optical recording medium side of the hollow portion, a magnetic circuit for driving the objective lens holder by a magnetic force, and an anti-collision member disposed on an objective lens supporting side of the objective lens holder so as to protrude from the objective lens holder, the anti-collision member preventing a collision between the objective lens and the optical recording medium, wherein
at least two of the anti-collision members are provided and disposed substantially symmetrically with respect to the objective lens, and each of the anti-collision members includes a fixing portion for fixing to the objective lens holder, a gradient portion extending from the fixing portion in the same direction as a rotation direction of the optical recording medium in a slanting manner by a predetermined angle with respect to the optical recording medium, and a contact portion that extends from the gradient portion and has a surface substantially parallel with the recording surface and may contact the optical recording medium, so that the anti-collision member can bend toward the objective lens holder when the anti-collision member contacts with the optical recording medium.
